(19) United States
(12) Patent Application Publication
(10) Pub. No.: US 2026/0121489 A1
(43) Pub. Date: Apr. 30, 2026

(54) MOTOR SYSTEM

(71) Applicant: MAZDA MOTOR CORPORATION, Hiroshima (JP)

(72) Inventors: Kentaro KAWAGUCHI, Aki-gun (JP); Yuma MIYAUCHI, Aki-gun (JP)

(73) Assignee: MAZDA MOTOR CORPORATION, Hiroshima (JP)

(21) Appl. No.: 19/350,117

(22) Filed: Oct. 6, 2025

(30) Foreign Application Priority Data
Oct. 25, 2024 (JP) 2024-188024

(51) Int. Cl. H02K 11/30; F16C 17/02; H02K 7/00; H02K 7/08

(52) U.S. Cl. CPC H02K 11/30; F16C 17/02; H02K 7/003; H02K 7/08; F16C 2380/26

(57) ABSTRACT

A motor system having a control device configured to adjust a mixing ratio Rmix of a CO₂ fluid and a lubricating oil by a flow rate control valve, according to a rotational speed r of a rotating shaft detected by a rotation sensor, wherein the control device controls the flow rate control valve to supply both the CO₂ fluid and the lubricating oil to a slide bearing in a starting/stopping interval in which the rotational speed is less than a predetermined set rotational speed.

### CROSS-REFERENCE TO RELATED APPLICATION

The present application claims priority to Japanese Patent Application 2024-188024, filed Oct. 25, 2024, the entire contents of which are incorporated herein by reference.

### BACKGROUND

### Field

The present disclosure relates to a motor system, particularly to a motor system having a slide bearing.

### Description of the Related Art

Conventionally, a slide bearing, which supports a rotating shaft and is lubricated with lubricating oil, reduces sliding resistance between the rotating shaft and the slide bearing via a lubrication coating film (oil film) made by the lubricating oil. Slide bearings for reducing an increase in sliding resistance in such a bearing structure, particularly under low-temperature environments, have been proposed (see, for example, Patent Literature 1).

In the slide bearing of Patent Literature 1, a surface structure of the slide bearing (a structure of a sliding surface) is configured to prevent frictional heat, which is caused by sliding between the rotating shaft and the slide bearing at the start of movement, from being conducted to the main body of the rotating shaft. Therefore, in the slide bearing of Patent Literature 1, the viscosity of the lubricating oil can be decreased by the frictional heat, and hence a reduction in the sliding resistance at the start of movement is expected.

### CITATION LIST

### Patent Literature

[Patent Literature 1] Japanese Unexamined Patent Publication No. 2021-8914

### SUMMARY

However, the present inventor has found that, in a case where such a slide bearing of Patent Literature 1 is applied to a rotor's rotating shaft of an electric motor, there is a risk that during starting and stopping of the electric motor (particularly, in an extremely low-speed range), a lubrication coating film with sufficient thickness is not formed between the rotating shaft and the slide bearing, and the rotating shaft and the slide bearing come into contact with each other, which may cause wear of a bearing unit.

Such wear causes an increase in bearing clearance, generation of abnormal noise, and a decrease in electromagnetic efficiency. Supplying a large amount of lubricating oil to the slide bearing from the outside can be considered to reduce such wear. However, when the slide bearing is configured in such a manner, there will be problems of scattering of the lubricating oil from the bearing unit to the inside of the motor and an increase in resistance to stirring during operation of the motor.

The present disclosure has been made to solve the problems of the prior art, and an object of the present disclosure is to provide a motor system that improves wear resistance of a bearing unit during starting and stopping of rotation.

### Means for Solving the Problems

In order to attain the object, a motor system of the present disclosure is characterized in including: a slide bearing that supports a rotating shaft of a rotating body; a rotation sensor for detecting a rotational speed of the rotating shaft; a supply unit that supplies each of a CO₂ fluid and a lubricating oil constituting a refrigerant toward the slide bearing; a flow rate control valve including a first control valve provided in a first flow passage for supplying the CO₂ fluid from the supply unit to the slide bearing, and a second control valve provided in a second flow passage for supplying the lubricating oil from the supply unit to the slide bearing; and a control device configured to adjust a mixing ratio of the CO₂ fluid and the lubricating oil via the flow rate control valve, according to the rotational speed of the rotating shaft detected by the rotation sensor, wherein the control device controls the flow rate control valve to supply both the CO₂ fluid and the lubricating oil to the slide bearing in a starting/stopping interval in which the rotational speed is less than a predetermined set rotational speed.

According to the present disclosure thus configured, both the CO₂ fluid and the lubricating oil are supplied to the slide bearing in an extremely low-speed range when the rotation of the rotating shaft is started and stopped (specifically, a starting/stopping interval in which the rotational speed is less than the set rotational speed). In this configuration, on a sliding surface of the rotating shaft and/or the slide bearing, formation of a chemical reaction film having wear resistance is facilitated by a surface reaction caused by friction, thereby making it possible to improve the wear resistance of the rotating shaft and the slide bearing serving as a bearing unit, particularly in the low-speed range.

Moreover, in the present disclosure, the set rotational speed is equivalent to a rotational speed at which the slide bearing and the rotating shaft start to come into direct contact with each other when the rotational speed of the rotating shaft decreases in a state in which the lubricating oil is being supplied. According to the present disclosure thus configured, the formation of the chemical reaction film can be facilitated in a rotational speed range in which direct contact between the slide bearing and the rotating shaft can occur.

Moreover, in the present disclosure, the control device preferably controls the flow rate control valve to decrease the mixing ratio of the CO₂ fluid in the refrigerant as the rotational speed increases in a transitional interval between a first rotational speed and the set rotational speed in which the rotational speed is greater than zero and less than the set rotational speed. According to the present disclosure thus configured, it is possible to reduce the risk of inhibiting the formation of the chemical reaction film by gradually changing the mixing ratio in the transitional interval.

Further, in the present disclosure, the control device preferably controls the flow rate control valve to set the mixing ratio of the CO₂ fluid in the refrigerant to zero when the rotational speed is equal to the set rotational speed. According to the present disclosure thus configured, it is possible to reduce the wear of the bearing unit by an oil film made by the lubricating oil, at least in a state in which the rotational speed is equal to the set rotational speed.

Furthermore, in the present disclosure, the control device preferably controls the flow rate control valve to increase the mixing ratio of the CO₂ fluid in the refrigerant as the rotational speed increases in an operating interval in which the rotational speed is greater than the set rotational speed. According to the present disclosure thus configured, when the rotational speed is greater than the set rotational speed and after a transition from the starting/stopping state to the operating state, the slide bearing is lubricated by the CO₂ fluid rather than by the lubricating oil. Consequently, in the present disclosure, it is possible to maintain good lubrication while reducing resistance to stirring caused by scattering of the lubricating oil to the rotating body.

Moreover, in the present disclosure, the control device preferably maintains the mixing ratio of the CO₂ fluid in the refrigerant at zero in a low-speed rotation interval in which the rotational speed is between the set rotational speed and a second rotational speed greater than the set rotational speed. According to the present disclosure thus configured, in the low-speed rotation interval, it is possible to reduce the wear of the bearing unit by an oil film made by the lubricating oil.

Further, in the present embodiment, the first flow passage and the second flow passage are preferably configured to merge before reaching the slide bearing and supply the CO₂ fluid and the lubricating oil to the slide bearing. According to the present disclosure thus configured, it is possible to supply the refrigerant to the slide bearing in a state in which the CO₂ fluid and the lubricating oil are mixed in a predetermined mixing ratio.

Furthermore, in the present disclosure, the first flow passage and the second flow passage are preferably configured to supply the CO₂ fluid and the lubricating oil independently of each other to the slide bearing. According to the present disclosure thus configured, after each of the CO₂ fluid and the lubricating oil is individually supplied to the slide bearing 20, the CO₂ fluid and the lubricating oil can be mixed within the slide bearing.

Additionally, in the present disclosure, the rotating body is preferably a rotor of an electric motor. According to the present disclosure thus configured, the refrigerant can lubricate the slide bearing of the electric motor and cool the inside of the electric motor, which generates heat during operation.

### Advantages

According to the motor system of the present disclosure, the motor system that reduces an increase in resistance to stirring and improves the wear resistance of the bearing unit during starting and stopping of rotation can be provided.

### BRIEF DESCRIPTION OF THE DRAWINGS

The scope of the present disclosure is best understood from the following detailed description of exemplary embodiments when read in conjunction with the accompanying drawings.

FIG. 1 is a schematic configuration diagram of a motor system according to an embodiment of the present disclosure.

FIG. 2 is an electrical block diagram of the motor system according to the embodiment of the present disclosure.

FIG. 3 is a graph showing the mixing ratio of a CO₂ fluid according to the embodiment of the present disclosure.

FIG. 4 is an explanatory view of a lubrication coating according to the embodiment of the present disclosure.

FIG. 5 is an explanatory view showing the relationship between relative velocity and oil film thickness according to the embodiment of the present disclosure.

FIG. 6 is a graph showing the relationship between the rotational speed and the oil film thickness in a sliding portion according to the embodiment of the present disclosure.

FIG. 7 is a control flow of the motor system according to the embodiment of the present disclosure.

FIG. 8 is a partial configuration diagram of a motor system according to another embodiment of the present disclosure.

### DETAILED DESCRIPTION

A motor system according to an embodiment of the present disclosure will be described below with reference to the attached drawings.

### [Overall Configuration]

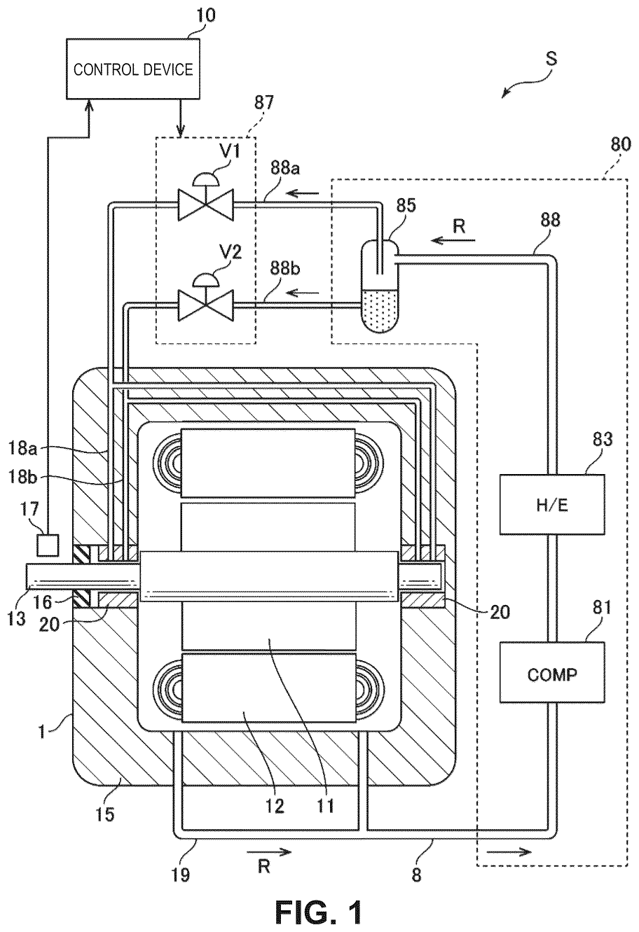

First, referring to FIG. 1, an overall configuration of a motor system (bearing device) according to the present embodiment will be described. FIG. 1 is a schematic configuration diagram of the motor system according to the present embodiment. A motor system S shown in FIG. 1 is mounted, for example, on a vehicle such as an electric automobile, and can provide a rotational driving force to the vehicle.

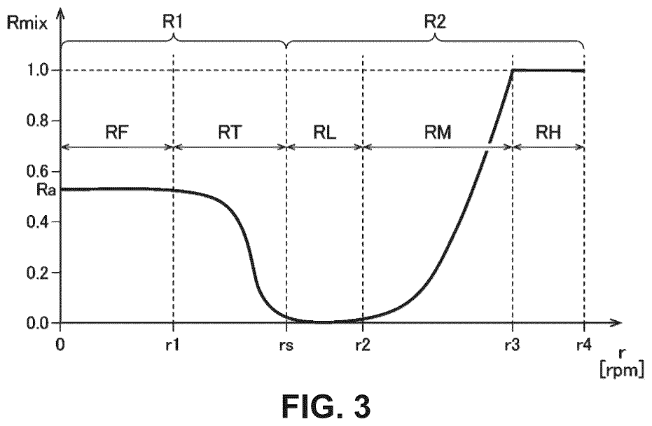

According to the present embodiment, in an extremely low-speed rotation range (starting/stopping interval R1, see FIG. 3) when a motor is started and stopped, a reaction film is formed on a sliding surface of a rotor shaft to improve wear resistance. Specifically, in the present embodiment, by supplying CO₂ fluid as well as lubricating oil to a bearing unit, a coating film (such as a carbonate film) having wear resistance is formed on the sliding surface using a surface reaction caused by friction.

The motor system S includes an electric motor (motor) 1, a refrigerant circulation system 8, and a control device 10 (hereinafter the control device 10 is the same as control circuitry 10). The electric motor 1 provides a rotational driving force to the vehicle. The refrigerant circulation system 8 is configured to circulate a refrigerant R in a refrigeration cycle to cool the electric motor 1. Specifically, in this refrigeration cycle, an expansion stroke and an evaporation stroke of the refrigerant R are executed in the electric motor 1, and a compression stroke and a condensation stroke of the refrigerant R are executed in the refrigerant circulation system 8.

In the present embodiment, the electric motor 1 is an ultra-high-speed rotating motor that can operate at a high rotational speed exceeding, for example, 30,000 rpm, and is configured to operate in a high-speed rotation interval RH (see FIG. 3) during normal operation. Although the refrigerant R is a mixture of CO₂ fluid, which is a natural refrigerant, and lubricating oil (for example, PAG oil), a bearing 20 is configured to be lubricated only by the CO₂ fluid in the high-speed rotation interval RH.

### [Configuration of Refrigerant Circulation System]

The refrigerant circulation system 8 has: a compressor 81 for compressing the refrigerant R; a heat exchanger (condenser) 83, including a condenser and a fan, for cooling the refrigerant R compressed by the compressor 81; a gas-liquid separator 85 for separating the refrigerant R discharged from the heat exchanger 83 into gas (CO₂ fluid) and liquid (lubricating oil); a flow rate control valve 87 (first control valve V1, second control valve V2) for adjusting the flow rates of the CO₂ fluid and the lubricating oil, respectively; and a flow passage 88 connecting these valves. The flow passage 88 branches into two passages (a first flow passage 88a in which the first control valve V1 is disposed, and a second flow passage 88b in which the second control valve V2 is disposed) downstream of the gas-liquid separator 85, and each of the passages is connected to the electric motor 1. The electric motor 1 is incorporated into the refrigerant circulation system 8. In the present embodiment, the compressor 81, the heat exchanger 83, and the gas-liquid separator 85 are a supply unit (supply) 80 of the refrigerant R.

### [Configuration of Motor]

The electric motor 1 according to the present embodiment includes: a rotor (rotating body) 11; a stator 12; a rotor shaft (rotating shaft) 13 fixed to the rotor 11 and extending in an axial direction; a pair of bearings (slide bearings) 20 that rotatably support the rotor shaft 13; a housing 15 that accommodates and supports the rotor 11, the stator 12, the rotor shaft 13, the bearings 20, etc.; a sealing member 16 that seals between the housing 15 and the rotor shaft 13 and prevents the refrigerant R from leaking out from the inside of the housing 15; and a rotation sensor 17 that detects the rotational speed of the rotor shaft 13. One end of the rotor shaft 13 is connected to a transaxle or the like of the vehicle.

The stator 12, which has a substantially cylindrical shape, is structured by winding a coil around a stator core. The rotor 11 has a rotor core, and a plurality of permanent magnets attached to the rotor core. The rotor shaft 13 is fixed to the rotor core. The rotor 11 is configured to be rotatable within the stator 12 with the rotor shaft 13 as a rotation axis.

The electric motor 1 further has: refrigerant supply flow passages 18a, 18b for supplying the refrigerant R supplied from the refrigerant circulation system 8 to the bearings 20; and a refrigerant discharge passage 19 for returning the refrigerant R from the inside of the electric motor 1 to the refrigerant circulation system 8. The refrigerant supply flow passages 18a, 18b are portions of the first flow passage 88a and the second flow passage 88b, respectively.

More specifically, the refrigerant supply flow passages 18a, 18b supply the CO₂ fluid and the lubricating oil, respectively, to the gap between the rotor shaft 13 and each bearing 20. Consequently, the refrigerant R is supplied for lubrication to the sliding surfaces of the rotor shaft 13 and each bearing 20. In the present embodiment, the CO₂ fluid, which is supplied to each bearing 20, is a high-pressure gas or a supercritical fluid. The CO₂ fluid and the lubricating oil used as lubricants leave each bearing 20, enter the housing 15, exchange heat with motor components, and then return to the refrigerant circulation system 8 through the refrigerant discharge passage 19.

### [Refrigeration Cycle of Refrigerant]

In the present embodiment, the compressor 81 receives the refrigerant R having a high temperature and a low pressure from the electric motor 1, compresses the received refrigerant R, and dispenses the refrigerant R having a high temperature and a high pressure. Next, the heat exchanger 83 exchanges heat between the high-temperature, high-pressure refrigerant R and external environments (cold air, cooling water, etc.) to generate the refrigerant R having a medium temperature and a high pressure. The medium-temperature, high-pressure refrigerant R is supplied to the bearings 20 of the electric motor 1, and lubricates the bearings 20. The refrigerant R that has lubricated the bearings 20 expands when entering an inner space of the housing 15, and becomes the low-temperature, low-pressure refrigerant R. Further, the low-temperature, low-pressure refrigerant R exchanges heat with a high-temperature portion of the electric motor 1 in the housing 15, and becomes the high-temperature, low-pressure refrigerant R. This high-temperature, low-pressure refrigerant R is returned to the compressor 81.

### [Bearing Structure]

The bearings 20 rotatably support the ends of the rotor shaft 13. Each bearing 20 has a generally cylindrical main body portion containing a metal material such as iron, and includes a sliding surface that is an inner circumferential surface of the main body, and an outer circumferential surface of the main body. The sliding surface supports the rotor shaft 13. Moreover, the main body portion is formed with a through-hole that penetrates a side wall from the outer circumferential surface and communicates with the sliding surface. The through-hole communicates with each refrigerant supply flow passage 18a, 18b, and forms a portion of each refrigerant supply flow passage 18a, 18b.

### [Electrical Block Diagram]

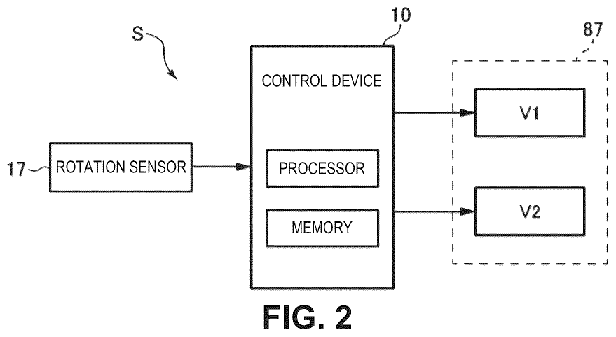

FIG. 2 is an electrical block diagram of the motor system. The control device 10 is a computer, including a processor, memory, etc., receives a rotation signal from the rotation sensor 17 provided in the motor system S, and outputs a valve opening degree signal to the flow rate control valve 87. More specifically, the control device 10 outputs a valve opening degree signal according to a rotational speed r (rpm) of the electric motor 1, and adjusts the valve opening degree of each of the first control valve V1 and the second control valve V2 to control a mixing ratio Rmix and the flow rates of the CO₂ fluid and the lubricating oil in the refrigerant R, which is supplied to the bearings 20.

The control device 10 can also be configured to receive signals (such as a refrigerant temperature, a refrigerant pressure, a refrigerant flow rate, and a stator temperature) from other sensors provided in the motor system S, and to output operation signals to component devices of the refrigerant circulation system 8, a solenoid valve, an electromagnet (electromagnetic solenoid), etc.

### [Overview of Flow Rate Adjustment Control]

Next, referring to FIG. 3, flow rate adjustment control by the control device 10 will be described. FIG. 3 shows the relationship between the rotational speed r and the mixing ratio Rmix of the CO₂ fluid in the refrigerant R. In the present embodiment, the control device 10 stores flow rate adjustment data shown in FIG. 3 in the memory. Based on this data, the control device 10 is configured to adjust the mixing ratio Rmix (for example, weight ratio) of the CO₂ fluid in the refrigerant R which is supplied to the bearings 20, according to the rotational speed r.

In the present embodiment, the electric motor 1 is configured to operate within a rotational speed range including the starting/stopping interval R1 (0 to rs) and an operating interval R2 (from r2). In the present embodiment, the mixing ratio of the CO₂ fluid in the refrigerant R which is supplied to the bearings 20 is controlled to vary according to the rotational speed.

Particularly in a high-speed rotation interval RH of from a third rotational speed r3 (for example, 10,000 rpm) to a fourth rotational speed r4 (for example, 30,000 rpm or higher) within the operating interval R2, the mixing ratio of the CO₂ fluid is set to 100%. In other words, the electric motor 1 of the present embodiment is a motor configured such that the bearings 20 are lubricated only by the CO₂ fluid in a predetermined rotational speed range (high-speed rotation interval RH).

In a predetermined medium-speed rotation interval RM of from a second rotational speed r2 (for example, 200 to 800 rpm) to the third rotational speed r3 within the operating interval R2, the lower the rotational speed r, the smaller the mixing ratio of the CO₂ fluid in the refrigerant R, and the mixing ratio is 0% at the second rotational speed r2. In the present embodiment, the medium-speed rotation interval RM is a transitional interval until the rotational speed r of the electric motor 1 reaches the high-speed rotation interval RH.

Further, in a low-speed rotation interval RL of from the set rotational speed rs (for example, 100 rpm) to the second rotational speed r2 (r2>rs) within the operating interval R2, the mixing ratio of the CO₂ fluid in the refrigerant R is maintained at 0%, and only the lubricating oil is supplied to the bearings 20.

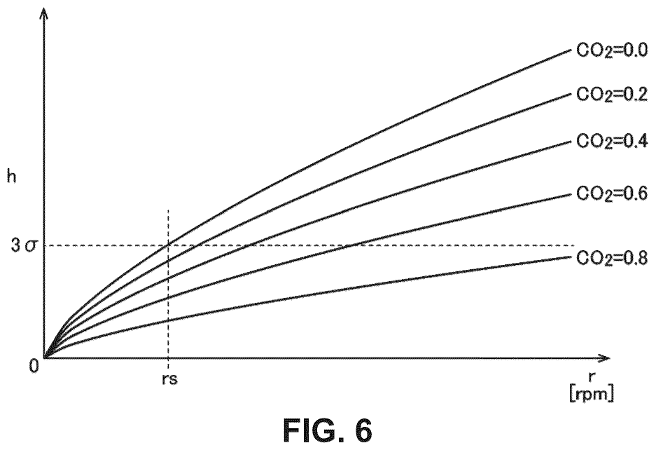

Note that, in the low-speed rotation interval RL, the mixing ratio of the CO₂ fluid in the refrigerant R is preferably 0%; however, this is not limitation and it may be set to a low mixing ratio within a range of, for example, 0% to 20%. When the mixing ratio is greater than 0%, the set rotational speed rs corresponding to 30 is set to a larger value as described while referring to FIG. 6.

Moreover, in the present embodiment, in the starting/stopping interval R1, the refrigerant R, which contains the CO₂ fluid as well as the lubricating oil, is supplied to the bearings 20. Specifically, in a predetermined transitional interval RT of from a first rotational speed r1 to the set rotational speed rs (r1<rs) within the starting/stopping interval R1, the lower the rotational speed r, the larger the mixing ratio of the CO₂ fluid in the refrigerant R, and the mixing ratio reaches a predetermined set mixing ratio Ra (for example, 50%) at the first rotational speed r1. Furthermore, the set mixing ratio Ra is maintained in a reaction film formation interval RF of from zero to the first rotational speed r1 within the starting/stopping interval R1. Thus, in the present embodiment, both the lubricating oil and the CO₂ fluid are supplied as the refrigerant R to the bearings 20 in the starting/stopping interval R1, in which the rotational speed is very low, immediately after the electric motor 1 is started and immediately before the electric motor 1 is stopped. Note that, in the present embodiment, in order to achieve a smooth transition of the mixing ratio between the set mixing ratio Ra and zero in the transitional interval RT, the first rotational speed r1 is set to the set rotational speed rs multiplied by a coefficient of from 0.6 to 0.9.

### [Lubrication Coating]

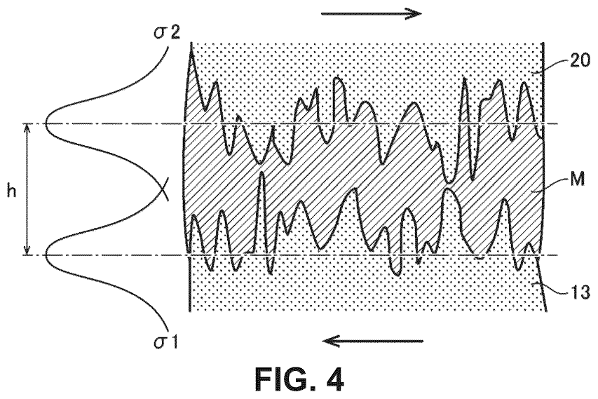

Next, referring to FIG. 4 to FIG. 6, a lubrication coating film (oil film) that is formed between two solid elements will be described. FIG. 4 shows a state in which an oil film M of lubricating oil with thickness h is formed between the sliding surfaces of two solid elements (the rotor shaft 13 and each bearing 20 in the present embodiment). Each of the sliding surfaces has a predetermined surface roughness. FIG. 4 schematically shows normal probability density distributions of the surface roughness, and the standard deviations of the surface roughness are σ1 and σ2, respectively.

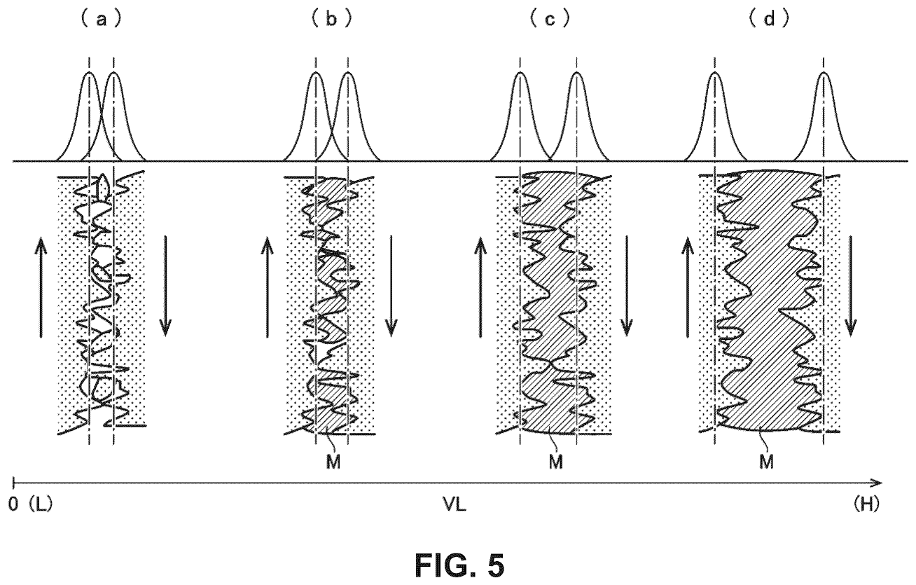

FIG. 5 shows, based on FIG. 4, the relationship between the lubrication coating film M formed between the two solid elements and a relative velocity VL of the two solid elements. As with FIG. 4, the normal probability density distributions of the surface roughness are also shown in FIG. 5. FIG. 5(a) shows a dry friction state, which occurs when the relative velocity is very small, and in which the solid elements come into contact with each other without the presence of a fluid (lubricating oil) on the friction surfaces (sliding surfaces), and the coefficient of friction is high. Next, FIG. 5(b) shows a boundary lubrication state, which occurs when the relative velocity is small, and in which a small amount of the fluid is present on the friction surfaces and the coefficient of friction is still high.

Next, FIG. 5(c) shows a mixed lubrication state, which occurs when the relative velocity is relatively small, and in which a certain amount of the fluid is present on the friction surfaces and the coefficient of friction is low. Next, FIG. 5(d) shows a fluid lubrication state, which occurs when the relative velocity is sufficiently high, and in which the friction surfaces are filled with the fluid, the solid elements do not contact each other, and the coefficient of friction is low. Thus, when the relative velocity is high, the oil film M with sufficient thickness is formed, thereby preventing direct contact between the solid elements. On the other hand, when the relative velocity is low, the oil film M with sufficient thickness is not formed, and the solid elements come into contact with each other.

In general, it is known that the film thickness h is inversely proportional to load W and proportional to velocity U and viscosity G, and this is expressed mathematically, for example, by the Dowson-Higginson Equation 1. The mathematical equation can be, for example,

$$h = 2.9 \; 22 {W}^{- 0.166} {U}^{0.692} {G}^{0.470} . \qquad ( Equation 1 )$$

FIG. 6 shows the relationship between the rotational speed r (rpm) and the film thickness h of the lubrication coating film formed between the rotor shaft 13 and the bearings 20, which is calculated based on Equation 1 to conform to the present embodiment. FIG. 6 shows the relationship for each case when the mixing ratio of the CO₂ fluid in the refrigerant R is changed (when the CO₂ fluid is 0%, 20%, 40%, 60%, and 80%). When the CO₂ fluid is 0%, the lubricating oil is 100%. As shown in FIG. 6, the film thickness h of the oil film increases as the rotational speed increases.

The present inventor has found that, taking into consideration the surface roughness of two solid elements (the rotor shaft 13 and each bearing 20), the time when the film thickness h of the oil film is three times a composite standard deviation σ of the surface roughness of the two solid elements corresponds to a transitional interval from the fluid lubrication state to the mixed lubrication state. In other words, when the film thickness h becomes less than 3σ, the coefficient of friction between the two solid elements starts changing from a low state to a high state (that is, the two solid elements start coming into direct contact with each other).

When the standard deviations of the surface roughness of the two solid elements are σ1 and σ2, respectively, the composite standard deviation σ is expressed as:

$$σ = \sqrt{σ {1}^{2} + σ {2}^{2}} .$$

Therefore, in the present embodiment, a rotational speed at which h=3σ is set as the set rotational speed rs in the graph of FIG. 6. As shown in FIG. 3, in the low-speed rotation interval RL (rs to r2), the refrigerant R which is supplied to the bearings 20 contains only the lubricating oil, but, since the film thickness h is at least 3σ or greater (h>3σ), wear is unlikely to occur between the rotor shaft 13 and the bearings 20. Moreover, in the present embodiment, in other intervals RM and RH within the operating interval R2, although the refrigerant R contains the CO₂ fluid, wear is unlikely to occur. On the other hand, in the starting/stopping interval R1 (0 to rs), since the film thickness h is less than 30, there is a risk of wear due to direct contact between the solid elements.

Note that the set rotational speed rs is not limited to the above, and may be set experimentally. In this case, for example, when the rotational speed of the rotor shaft 13 is decreased, a rotational speed at which rotational resistance increases may be set as the set rotational speed rs. Moreover, physical contact between the rotor shaft 13 and each bearing 20 may be observed, and a rotational speed at which physical contact starts to occur may be set as the set rotational speed rs.

Thus, in the starting/stopping interval R1, contact between the solid elements may occur. However, the present inventor has found that it is possible to provide wear resistance to the solid elements (rotor shaft 13 and/or bearing 20) by using a chemical reaction film. The chemical reaction film (for example, tribo-reaction film) is a strong film (for example, iron carbonate FeCO₃) that is formed on the surfaces of various materials (such as steel) due to an interaction, such as friction, in the presence of the CO₂ fluid and lubricating oil. For the formation of the chemical reaction film, the presence of the lubricating oil as well as the CO₂ fluid is preferred. Note that at least one of the rotor shaft 13 and the bearings 20 contains a material (such as Fe) that is a component of the chemical reaction film.

Therefore, in the present embodiment, in the reaction film formation interval RF (0 to r1) within the starting/stopping interval R1, the refrigerant R containing only the set mixing ratio Ra of the CO₂ fluid in addition to the lubricating oil is supplied to each bearing 20 to form the chemical reaction film on the sliding surfaces of the two solid elements, thereby improving the wear resistance. In other words, in the present embodiment, in a range of rotational speeds in which contact between the solid elements may occur, wear of the solid elements can be reduced by causing the solid elements to come into contact with each other through the chemical reaction film.

Moreover, in the present embodiment, in the transitional interval RT (r1 to rs), the mixing ratio Rmix of the CO₂ fluid is decreased as the rotational speed r increases, and, at the set rotational speed rs, the refrigerant R composed only of the lubricating oil is supplied to each bearing 20. In this transitional interval RT, a chemical reaction film is also formed.

In the present embodiment, in the starting/stopping interval R1, the set mixing ratio Ra is selected to facilitate the formation of the chemical reaction film. In other words, supplying a greater amount of the CO₂ fluid to the sliding surfaces is more advantageous for the formation of the chemical reaction film, but, if the CO₂ fluid in a state of not being dissolved in the lubricating oil is supplied to the sliding surfaces, the CO₂ fluid may, on the contrary, inhibit the formation of the chemical reaction film. Therefore, with the use of known data such as a predetermined Daniel chart or two-layer separation temperature diagram, the set mixing ratio Ra of the lubricating oil and the CO₂ fluid is determined based on a temperature set for supplying the refrigerant R so that the mixing ratio provides miscibility.

### [Process Flow]

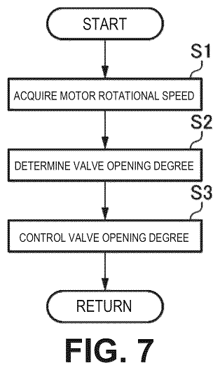

Next, referring to FIG. 7, a process flow of the motor system S will be described. The control device 10 constantly and repeatedly executes the process of FIG. 7 when the electric motor 1 is operated. When the process is started, the control device 10 detects, based on a rotation signal received from the rotation sensor 17, the rotational speed (rpm) of the rotor shaft 13 (S1). Next, the control device 10 determines, based on the detected rotational speed and using the flow rate adjustment data stored in the memory (see FIG. 3), the mixing ratio Rmix of the CO₂ fluid in the refrigerant R, and determines an opening degree of the flow rate control valve 87 to achieve this mixing ratio (S2). Specifically, the opening degrees of the respective first control valve V1 and second control valve V2 are set to achieve the determined mixing ratio Rmix.

Next, the control device 10 outputs valve opening degree signals to the first control valve V1 and the second control valve V2 so as to achieve the determined valve opening degrees (S3), and then finishes the process. Consequently, the first control valve V1 and the second control valve V2 supply the CO₂ fluid and the lubricating oil toward each bearing 20 at flow rates corresponding to desired valve opening degrees.

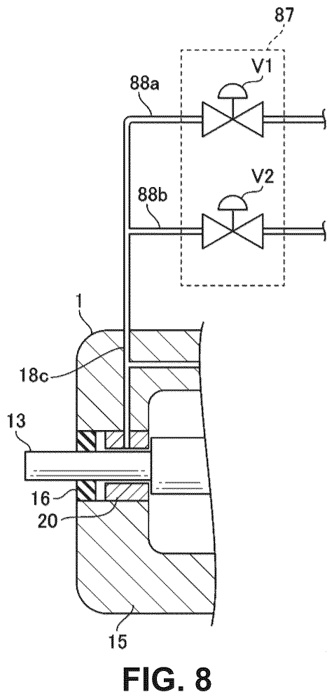

Note that, in the above embodiment, although the refrigerant supply flow passage 18a from the first control valve V1 and the refrigerant supply flow passage 18b from the second control valve V2 are each connected to the through-hole of each bearing 20, the refrigerant supply flow passages may be configured as shown in FIG. 8. In other words, after the first flow passage 88a and the second flow passage 88b (or the refrigerant supply flow passage 18a and the refrigerant supply flow passage 18b) merge, the resulting merged refrigerant supply flow passage 18c can be connected to the through-hole provided in each bearing 20.

### Functions and Effects

Next, functions and effects of the motor system S of the present embodiment will be described.

The motor system S according to the present embodiment is characterized in including: a slide bearing 20 that supports a rotating shaft 13 of a rotating body 11; a rotation sensor 17 for detecting a rotational speed r of the rotating shaft 13; a supply unit 80 that supplies each of a CO₂ fluid and a lubricating oil constituting a refrigerant R toward the slide bearing 20; a flow rate control valve 87 including a first control valve V1 provided in a first flow passage 88a for supplying the CO₂ fluid from the supply unit 80 to the slide bearing 20, and a second control valve V2 provided in a second flow passage 88b for supplying the lubricating oil from the supply unit 80 to the slide bearing 20; and a control device 10 configured to adjust the mixing ratio Rmix of the CO₂ fluid and the lubricating oil by the flow rate control valve 87, according to the rotational speed r of the rotating shaft 13 detected by the rotation sensor 17, wherein the control device 10 controls the flow rate control valve 87 to supply both the CO₂ fluid and the lubricating oil to the slide bearing 20 in a starting/stopping interval R1 in which the rotational speed r is less than a predetermined set rotational speed rs.

In such an embodiment, in an extremely low-speed range when the rotation of the rotating shaft 13 is started and stopped (specifically, in the starting/stopping interval R1 in which the rotational speed r is less than the set rotational speed rs), both the CO₂ fluid and the lubricating oil are supplied to the slide bearing 20. In this configuration, on the sliding surface of the rotating shaft 13 and/or the slide bearing 20, the formation of a chemical reaction film having wear resistance is facilitated by a surface reaction caused by friction, and, particularly in the low-speed range, the wear resistance of the rotating shaft 13 and the slide bearing 20 serving as a bearing unit can be improved.

Moreover, according to the present embodiment, the set rotational speed rs is equivalent to a rotational speed at which the slide bearing 20 and the rotating shaft 13 start coming into direct contact with each other when the rotational speed r of the rotating shaft 13 decreases in a state in which the lubricating oil is being supplied. In such an embodiment, the formation of the chemical reaction film can be facilitated in a rotational speed range in which direct contact between the slide bearing 20 and the rotating shaft 13 can occur.

Moreover, according to the present embodiment, the control device 10 controls the flow rate control valve 87 to decrease the mixing ratio Rmix of the CO₂ fluid in the refrigerant R as the rotational speed r increases in a transitional interval RT between a first rotational speed r1 and the set rotational speed rs in which the rotational speed r is greater than zero and less than the set rotational speed rs. In such an embodiment, the risk of inhibiting the formation of the chemical reaction film can be reduced by gradually changing the mixing ratio Rmix in the transitional interval RT.

Further, according to the present embodiment, the control device 10 controls the flow rate control valve 87 to set the mixing ratio Rmix of the CO₂ fluid in the refrigerant R to zero when the rotational speed r is equal to the set rotational speed rs. In such an embodiment, in a state in which at least the rotational speed r is equal to the set rotational speed rs, it is possible to reduce the wear of the bearing unit by an oil film made by the lubricating oil.

Furthermore, according to the present embodiment, the control device 10 controls the flow rate control valve 87 such that the mixing ratio Rmix of the CO₂ fluid in the refrigerant R is increased as the rotational speed r increases in an operating interval R2 in which the rotational speed r is greater than the set rotational speed rs. In such an embodiment, when the rotational speed r is greater than the set rotational speed rs and after a transition from the starting/stopping state to the operating state, the slide bearing 20 is lubricated by the CO₂ fluid rather than by the lubricating oil. Consequently, in the present embodiment, it is possible to maintain good lubrication while reducing resistance to stirring caused by scattering of the lubricating oil to the rotating body 11.

Moreover, according to the present embodiment, the control device 10 maintains the mixing ratio Rmix of the CO₂ fluid in the refrigerant R at zero in a low-speed rotation interval RL in which the rotational speed r is between the set rotational speed rs and a second rotational speed r2 greater than the set rotational speed rs. In such an embodiment, in the low-speed rotation interval RL, it is possible to reduce the wear of the bearing unit by the oil film made by the lubricating oil.

Further, according to the present embodiment, the first flow passage 88a and the second flow passage 88b are configured to merge before reaching the slide bearing 20 and supply the CO₂ fluid and the lubricating oil to the slide bearing 20. In such an embodiment, it is possible to supply the refrigerant R to the slide bearing 20 in a state in which the CO₂ fluid and the lubricating oil are mixed in a predetermined mixing ratio.

Furthermore, according to the present embodiment, the first flow passage 88a and the second flow passage 88b are configured to supply the CO₂ fluid and the lubricating oil independently of each other to the slide bearing 20. In such an embodiment, after each of the CO₂ fluid and the lubricating oil is individually supplied to the slide bearing 20, the CO₂ fluid and the lubricating oil can be mixed within the slide bearing 20.

Additionally, according to the present embodiment, the rotating body 11 is a rotor of the electric motor 1. In such an embodiment, the refrigerant R can lubricate the slide bearing 20 of the electric motor 1 and cool the inside of the electric motor 1, which generates heat during operation.

### REFERENCE SIGNS LIST

1 electric motor
8 refrigerant circulation system
10 control device
11 rotor (rotating body)
13 rotor shaft (rotating shaft)
20 slide bearing
80 supply unit
85 gas-liquid separator
87 flow rate control valve
V1 first control valve
V2 second control valve
R refrigerant
S motor system

1. A motor system comprising:
a slide bearing that supports a rotating shaft of a rotating body;
a rotation sensor for detecting a rotational speed of the rotating shaft;
a supply that supplies each of a CO₂ fluid and a lubricating oil constituting a refrigerant toward the slide bearing;
a flow rate control valve including a first control valve provided in a first flow passage for supplying the CO₂ fluid from the supply to the slide bearing, and a second control valve provided in a second flow passage for supplying the lubricating oil from the supply to the slide bearing; and
control circuitry configured to adjust a mixing ratio of the CO₂ fluid and the lubricating oil via the flow rate control valve, according to the rotational speed of the rotating shaft detected by the rotation sensor,
wherein the control circuitry controls the flow rate control valve to supply both the CO₂ fluid and the lubricating oil to the slide bearing in a starting/stopping interval in which the rotational speed is less than a predetermined set rotational speed.

2. The motor system according to claim 1, wherein the set rotational speed is equivalent to a rotational speed at which the slide bearing and the rotating shaft start to come into direct contact with each other when the rotational speed of the rotating shaft decreases in a state in which the lubricating oil is being supplied.

3. The motor system according to claim 1, wherein the control circuitry controls the flow rate control valve to decrease the mixing ratio of the CO₂ fluid in the refrigerant as the rotational speed increases in a transitional interval between a first rotational speed and the set rotational speed in which the rotational speed is greater than zero and less than the set rotational speed.

4. The motor system according to claim 1, wherein the control circuitry controls the flow rate control valve to set the mixing ratio of the CO₂ fluid in the refrigerant to zero when the rotational speed is equal to the set rotational speed.

5. The motor system according to claim 3, wherein the control circuitry controls the flow rate control valve to increase the mixing ratio of the CO₂ fluid in the refrigerant as the rotational speed increases in an operating interval in which the rotational speed is greater than the set rotational speed.

6. The motor system according to claim 5, wherein the control circuitry maintains the mixing ratio of the CO₂ fluid in the refrigerant at zero in a low-speed rotation interval in which the rotational speed is between the set rotational speed and a second rotational speed greater than the set rotational speed.

7. The motor system according to claim 1, wherein the first flow passage and the second flow passage are configured to merge before reaching the slide bearing and supply the CO₂ fluid and the lubricating oil to the slide bearing.

8. The motor system according to claim 1, wherein the first flow passage and the second flow passage are configured to supply the CO₂ fluid and the lubricating oil independently of each other to the slide bearing.

9. The motor system according to claim 1, wherein the rotating body is a rotor of an electric motor.

10. The motor system according to claim 2, wherein the control circuitry controls the flow rate control valve to decrease the mixing ratio of the CO₂ fluid in the refrigerant as the rotational speed increases in a transitional interval between a first rotational speed and the set rotational speed in which the rotational speed is greater than zero and less than the set rotational speed.

11. The motor system according to claim 2, wherein the control circuitry controls the flow rate control valve to set the mixing ratio of the CO₂ fluid in the refrigerant to zero when the rotational speed is equal to the set rotational speed.

12. The motor system according to claim 10, wherein the control circuitry controls the flow rate control valve to increase the mixing ratio of the CO₂ fluid in the refrigerant as the rotational speed increases in an operating interval in which the rotational speed is greater than the set rotational speed.

13. The motor system according to claim 12, wherein the control circuitry maintains the mixing ratio of the CO₂ fluid in the refrigerant at zero in a low-speed rotation interval in which the rotational speed is between the set rotational speed and a second rotational speed greater than the set rotational speed.

14. The motor system according to claim 2, wherein the first flow passage and the second flow passage are configured to merge before reaching the slide bearing and supply the CO₂ fluid and the lubricating oil to the slide bearing.

15. The motor system according to claim 2, wherein the first flow passage and the second flow passage are configured to supply the CO fluid and the lubricating oil independently of each other to the slide bearing.

16. The motor system according to claim 2, wherein the rotating body is a rotor of an electric motor.
